(19) United States
(12) Patent Application Publication
(10) Pub. No.: US 2024/0377204 A1
(43) Pub. Date: Nov. 14, 2024

(54) MAP INFORMATION SYSTEM, IN-VEHICLE DEVICE, AND MANAGEMENT SERVER

(71) Applicant: DENSO CORPORATION, Kariya-city (JP)

(72) Inventors: SHINYA ABE, Kariya-city (JP); SATOSHI HORIHATA, Kariya-city (JP)

(21) Appl. No.: 18/781,816

(22) Filed: Jul. 23, 2024

Related U.S. Application Data
(63) Continuation of application No. PCT/JP2023/002145, filed on Jan. 24, 2023.

(30) Foreign Application Priority Data
Jan. 26, 2022 (JP) 2022-010352

(51) Int. Cl. G01C 21/30; G01C 21/00

(52) U.S. Cl. CPC G01C 21/30; G01C 21/3837

(57) ABSTRACT

A map information system manages map information stored in a storage unit in a vehicle. The map information system includes an information generation unit that generates matching information indicating that periphery information, which is detected by a periphery detection sensor mounted on the vehicle, and the map information match each other when a difference between the periphery information and the map information is within an allowable range. The information generation unit does not generate difference information indicating that the periphery information and the map information do not match when the difference is out of the allowable range.

### CROSS REFERENCE TO RELATED APPLICATIONS

The present application is a continuation application of International Patent Application No. PCT/JP2023/002145 filed on Jan. 24, 2023, which designated the U.S. and claims the benefit of priority from Japanese Patent Application No. 2022-010352 filed on Jan. 26, 2022. The entire disclosures of all of the above applications are incorporated herein by reference.

### TECHNICAL FIELD

The present disclosure relates to a map information system, an in-vehicle device, and a management server that manage map information.

### BACKGROUND

A conventional map management server compares a position and shape of a feature detected by a sensor of a vehicle with map data. Difference information is sent to a map management server when it is determined that there is a change in the feature detected by the sensor. The map management server updates a map database based on the difference information.

### SUMMARY

According to at least one embodiment, a map information system manages map information stored in a storage unit in a vehicle. The map information system includes an information generation unit that generates matching information indicating that periphery information, which is detected by a periphery detection sensor mounted on the vehicle, and the map information match each other when a difference between the periphery information and the map information is within an allowable range. The information generation unit does not generate difference information indicating that the periphery information and the map information do not match when the difference is out of the allowable range.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating an overall configuration of a map update system according to a first embodiment.

FIG. 2 is a diagram illustrating a configuration of an in-vehicle system.

FIG. 3 is a flowchart illustrating a process of an in-vehicle device.

FIG. 4 is a diagram illustrating a configuration of a management server.

FIG. 5 is a flowchart illustrating a process of a server controller.

### DETAILED DESCRIPTION

To begin with, examples of relevant techniques will be described.

A map data management device according to a comparative example compares positions and shapes of features detected by an external sensor mounted on a vehicle with feature information of map data stored in a storage unit. Difference information is sent to a server when it is determined that there is a change in the feature detected by the external sensor. The server updates a map database based on the difference information.

In the map data management device of the comparative example, when the feature information contained in the map database differs from the position and the shape of the map detected by a sensor mounted on a vehicle that actually traveled through an area, the difference information is sent to the server.

In a program using a map database, for example, an automated driving program, it is important that map data is correct. If the map data is correct, the automated driving program will be able to perform automated driving appropriately. Therefore, matching information in which the map information matches information detected by the sensor is more important than the difference information of the map data management device of the comparative example, and collecting the matching information is necessary.

In contrast to the comparative example, according to a map information system, an in-vehicle device, and a management server of the present disclosure, matching information can be collected.

According to one aspect of the present disclosure, a map information system manages map information stored in a storage unit in a vehicle. The map information system includes an information generation unit that generates matching information indicating that periphery information, which is detected by a periphery detection sensor mounted on the vehicle, and the map information match each other when a difference between the periphery information and the map information is within an allowable range. The information generation unit does not generate difference information indicating that the periphery information and the map information do not match when the difference is out of the allowable range.

According to this configuration, the information generation unit generates the matching information indicating that the periphery information and the map information match when the difference between the periphery information detected by the periphery detection sensor mounted on the vehicle and the map information is within an allowable range. The matching information is information indicating that the map information is correct. Thus, the matching information can be collected.

According to one aspect of the present disclosure, an in-vehicle device mounted on a vehicle includes a storage unit that stores map information, an information generation unit, a vehicle communication unit, and a map update unit. The information generation unit generates matching information indicating that periphery information, which is detected by a periphery detection sensor mounted on the vehicle, and the map information match each other when a difference between the periphery information and the map information is within an allowable range. The information generation unit does not generate difference information indicating that the periphery information and the map information do not match when the difference is out of the allowable range. The vehicle communication unit communicates with a management server, transmits the matching information to the management server, and receives new map information from the management server. The map update unit updates the map information in the storage unit when the new map information is received from the management server.

According to this configuration, the information generation unit generates the matching information indicating that the periphery information matches the map information when a difference between the periphery information detected by the periphery detection sensor mounted on the vehicle and the map information is within the allowable range. The matching information is information indicating that the map information is correct. Since such matching information is transmitted to the management server, the management server is capable of calculating the reliability of the map using the matching information, and other vehicles are capable of using the map information having high reliability.

According to one aspect of the present disclosure, a management server communicates with an in-vehicle device mounted on vehicles and manages map information stored in a storage unit of the in-vehicle device. The management server includes a server communication unit that communicates with in-vehicle devices, a reliability calculation unit, an update determination unit that determines whether to update the map information using the reliability, and a control unit. The reliability calculation unit statistically processes pieces of matching information, and calculates reliability indicating certainty of the map information when the matching information is received from the in-vehicle devices. The control unit controls the server communication unit to transmit updated map information to the in-vehicle device when the map information is updated. The matching information includes information generated when a difference between periphery information, which is detected by a periphery detection sensor mounted on the vehicle and the map information, and the map information is within an allowable range and indicating that the periphery information matches the map information, a generation time point when the matching information is generated, and position information indicating a position of the vehicle when the matching information is generated.

According to this configuration, the matching information indicating that the periphery information matches the map information is received when a difference between the periphery information detected by the periphery detection sensor mounted on the vehicle and the map information is within the allowable range. The matching information is information indicating that the map information is correct. The reliability calculation unit calculates reliability indicating certainty of the map information using the matching information. Therefore, since the reliability of the map information can be known by generating the matching information, other vehicles are capable of using the map information having high reliability.

### First Embodiment

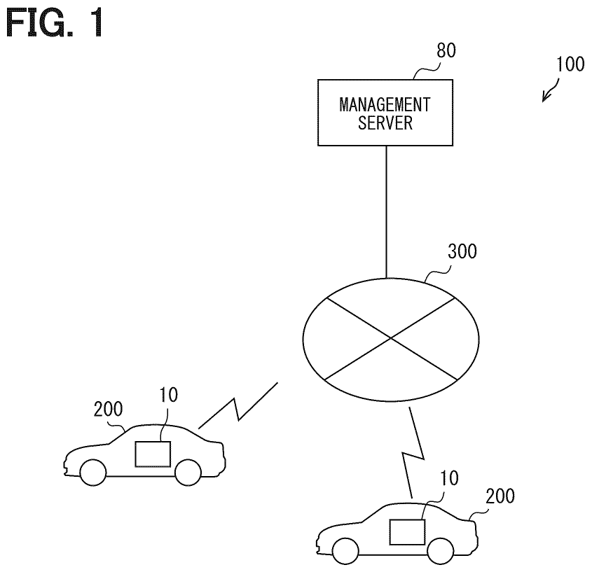

Hereinafter, a first embodiment of the present disclosure will be described with reference to FIGS. 1 to 5. FIG. 1 is a diagram illustrating an overall configuration of a map information system 100 of the present embodiment. The map information system 100 updates map information stored in a vehicle storage unit 30 located in a vehicle 200. The map information system 100 includes an in-vehicle system 10 mounted on the vehicle 200 and a management server 80 installed at an arbitrary position outside the vehicle 200. The in-vehicle system 10 and the management server 80 are capable of communicating via a communication network 300.

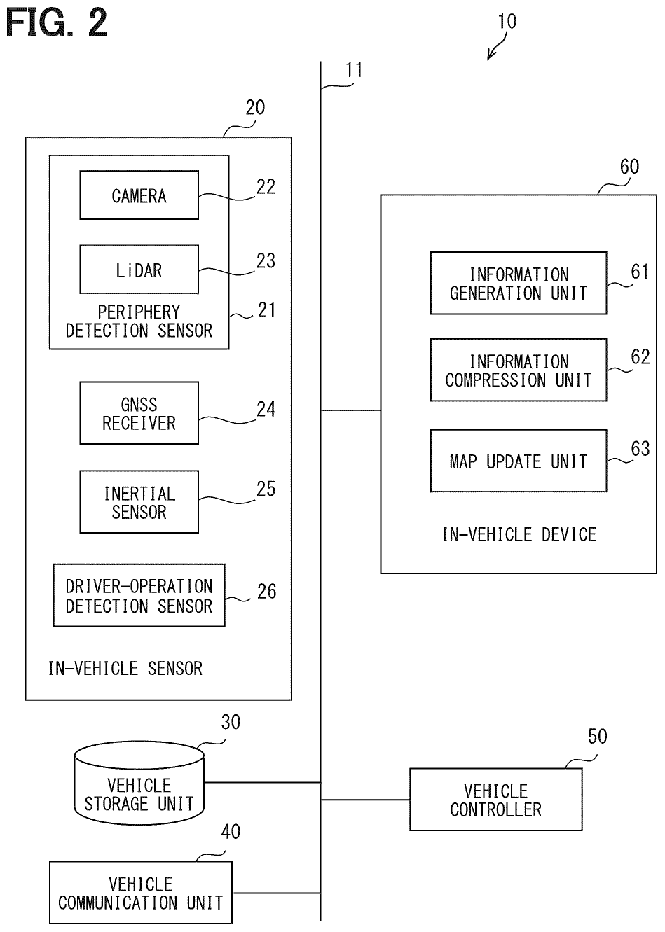

First, a configuration of the in-vehicle system 10 will be described with reference to FIG. 2. The in-vehicle system 10 includes an in-vehicle sensor 20, a vehicle storage unit 30, a vehicle communication unit 40, a vehicle controller 50, and an in-vehicle device 60. These are connected to an in-vehicle LAN 11 and communicate with each other via the in-vehicle LAN 11. The vehicle communication unit 40 is a communication unit that performs wireless communication, and communicates with the management server 80 via the communication network 300.

The in-vehicle sensor 20 is a sensor mounted on the vehicle 200 to detect various information used for vehicle control. The in-vehicle sensor 20 includes a periphery detection sensor 21, a GNSS receiver 24, an inertial sensor 25, and a driver-operation detection sensor 26. In addition to this, the in-vehicle sensor 20 may include other sensors such as a sensor that detects a driver state.

The periphery detection sensor 21 is mounted on the vehicle 200 and detects various objects existing in a periphery of the vehicle 200. The objects also include planar objects such as road surface markings and lane markings. In FIG. 2, a camera 22 and a LIDAR 23 are shown as the periphery detection sensor 21. The camera 22 captures an image in front of the vehicle 200. Further, the camera 22 may capture sides and a rear of the vehicle 200. The LiDAR 23 detects an object position in the periphery of the vehicle 200 by projecting and receiving light. In addition to or in place of these, the periphery detection sensor 21 may include other sensors that detect objects existing in the periphery of the vehicle 200, such as a millimeter wave radar. The periphery detection sensor 21 stores periphery information, which is information detected by the periphery detection sensor 21, in the vehicle storage unit 30.

The GNSS receiver 24 receives a navigation signal transmitted by a navigation satellite of a GNSS (Global Navigation Satellite System) and sequentially calculates a current position based on the received navigation signal. The inertial sensor 25 is a sensor that detects inertia generated in the vehicle 200, and includes one or both of an acceleration sensor and an angular velocity sensor. The GNSS receiver 24 and the inertial sensor 25 are sensors for sequentially detecting the current position of the vehicle 200. Since a change in the current position indicates the behavior of the vehicle 200, the GNSS receiver 24 and the inertial sensor 25 are sensors that detect information indicating behavior of the vehicle 200.

The driver-operation detection sensor 26 is a sensor that detects input operations performed by a driver to change or maintain the behavior of the vehicle 200. The driver-operation detection sensor 26 is an accelerator sensor, a brake sensor, a steering sensor, a shift position sensor, or the like.

The vehicle storage unit 30 is writable and stores various information. The vehicle storage unit 30 need not always be mounted on the vehicle 200, and may be detachable from the vehicle 200. For example, after the user stops the vehicle 200, the vehicle storage unit 30 may be removed and used by being connected to another information terminal in another place, for example, a company.

The vehicle storage unit 30 may use a flash memory. The vehicle storage unit 30 stores a map database (hereinafter referred to as map DB). The map DB includes map information. The map information includes sign information for specifying types of road signs, road surface markings, and lane markings. Road signs, road surface markings, and lane markings are defined by law and are provided to allow traffic on a road to travel safely and smoothly. The road sign is, for example, an information sign, a warning sign, a regulation sign, and an instruction sign. The sign information is information for specifying the type and content thereof. The map information is realized by, for example, map information called a high-precision map.

The high-precision map is a three-dimensional map and includes information about features existing in the periphery of the road. The features include traffic lights and road signs. The information on the traffic lights is traffic light information for specifying a traffic signal, such as coordinates, a signal shape, a size, and a direction of the traffic signal. The high-precision map includes not only three-dimensional information but also two-dimensional information existing on a surface of the road. The two-dimensional information is, for example, a type of the road surface marking, the position of the road surface marking, the position of the lane marking, and the type of the lane marking.

The vehicle controller 50 acquires behavior information indicating the behavior of the vehicle 200 and the periphery information indicating objects existing in the periphery of the vehicle 200 from the in-vehicle sensor 20. The vehicle controller 50 also acquires map information from the map DB stored in the vehicle storage unit 30. The vehicle controller 50 uses the acquired information to execute the vehicle control to control the behavior of the vehicle 200. The vehicle controller 50 can be implemented by a configuration including at least one processor.

An example of the vehicle control is traffic light stop control. The traffic light stop control is a control for stop at a stop line when the target traffic light is red and the vehicle is not traveling in a traveling lane in a direction indicated by an arrow light. When traffic lights can be detected by the periphery detection sensor 21, which one of the traffic lights is the target traffic light is determined based on positions of the traffic lights and directions of the traffic lights with respect to the vehicle 200. In the traffic light stop control, a target traffic light is identified from the traffic light detected by the periphery detection sensor 21 using the traffic light information in the map information. Then, it is determined which light of the specified target traffic light is lit.

Another example of the vehicle control is lane keeping control. The lane keeping control is control in which the vehicle 200 automatically travels in the same lane while sequentially detecting a position of the lane marking and the vehicle 200 in a vehicle width direction. The lane keeping control is performed using a position and a shape of a lane marking recognized using the periphery detection sensor 21 with the position and the shape of the lane marking in the map information.

The in-vehicle device 60 is used by being mounted on the vehicle 200. The in-vehicle device 60 is implemented by a configuration which includes at least one processor. For example, the in-vehicle device 60 may be implemented by a computer including a processor, a non-volatile memory, a random access memory (i.e., RAM), an input-output (I/O), and a bus line connecting these components. The non-volatile memory stores a program that operates a general-purpose computer as the in-vehicle device 60. The processor executes the program stored in the non-volatile memory and uses a temporary storage function of the RAM. As shown in FIG. 2, the in-vehicle device 60 includes an information generation unit 61, an information compression unit 62, and a map update unit 63 as functional blocks. Execution of the functional blocks correspond to an execution of a method implemented by execution of the program.

The information generation unit 61 generates matching information indicating that the periphery information matches the map information when a difference between the periphery information detected by the periphery detection sensor 21 and the map information in the map DB is within an allowable range. The difference between the periphery information and the map information is, for example, a difference in position of a feature, a difference in position of a road surface marking, a difference in line type of a lane marking, or the like. In a determination of whether the difference between the periphery information and the map information is within the allowable range, if the difference can be regarded as a detection error of the periphery detection sensor 21, the information generation unit 61 determines that the difference is within the allowable range, and generates the matching information. The information generation unit 61 stores the generated matching information in the vehicle storage unit 30 as the matching information including a generation time point and position information of the vehicle 200 at a time of generation. The matching information is generated for each of the compared targets and also includes information on the compared positions. Therefore, the matching information is, for example, information indicating that the lane markings match over a predetermined section of a certain road, or information indicating that the position and type of a certain road sign at a certain intersection match.

The information generation unit 61 does not generate difference information indicating a mismatch when the difference is out of the allowable range. In other words, the information generation unit 61 generates only the matching information. Therefore, since the difference information indicating the difference between the map information and the periphery information is not generated, the difference information is not transmitted to the management server 80 or the like.

The information generation unit 61 generates the matching information if the difference in the position is within an allowable value when the difference between the periphery information and the map information is a difference in the position of the target feature. The allowable value is set, for example, by using a difference between the detected positions of the lane markings at which the lane keeping control can be performed. The allowable value is individually set according to a detection target. Therefore, the difference between a detection position of a lane marking and the difference between a detection position of a road sign installed as a signboard have different allowable values. For example, in a case of a difference in a detection position of a road sign installed as a signboard, a value is set to a value larger than an allowable value of a lane marking. This is because the difference between the detected positions of the lane marking requires a high positional accuracy to better control the travel of the vehicle 200.

The matching information is generated when there is a difference of, for example, 100 mm or less, which is an allowable value, between a position of a feature in the periphery information and a position of the feature in the map information. On the other hand, the matching information is not generated when the position of the feature exceeds the allowable value of 100 mm, for example.

The information generation unit 61 generates the matching information when a type specified based on the sign information of the periphery information and the sign information of the map information match. For example, in a case where a lane marking is a broken line in the periphery information and a lane marking is a solid line in the map information, the types are different, but the lane markings match in that there is a lane marking, and thus the matching information is generated. For example, in a case of a speed limit sign, when a difference between the periphery information and the map information is a difference in speed value, it is determined that the types are the same, and the matching information is generated. The determination of these types can be appropriately set.

The information generation unit 61 specifies one traffic light closest to a traveling direction of the vehicle 200 by using the positions of the traffic lights with respect to the vehicle 200 and an orientation of the vehicle 200 when the periphery information includes information indicating detection of the traffic lights. In other words, the information generation unit 61 specifies one traffic signal which is located in front of the vehicle 200 and is used for the latest travel control from the traffic lights. The information generation unit 61 determines that the specified position of the traffic light is within the allowable range and generates the matching information when the specified position of the traffic lights matches the position information of the traffic light included in the traffic light information.

The information generation unit 61 stops generating the matching information when the in-vehicle system 10 outputs abnormality information indicating an abnormality. The abnormality information is output by the in-vehicle system 10, for example, when the automated driving cannot be continued. The case where the automated driving cannot be continued is, for example, a case where the map information and the sensor information are significantly different from each other. The abnormality information is also output from the in-vehicle system 10 during execution of the automated driving in an emergency different from normal automated driving, for example, during execution of emergency avoidance control or emergency stop control by detecting an obstacle ahead.

The abnormality information is also output when there is a malfunction in the vehicle control executed by the vehicle controller 50. The malfunction of the vehicle control is, for example, a state in which an error occurs in information output by one or more in-vehicle sensors 20 used by the vehicle controller 50 for the vehicle control. Examples of cases where the information output by the in-vehicle sensor 20 is an error include a case where the in-vehicle sensor 20 is malfunctioned, and a case where the in-vehicle sensor 20 is not malfunctioned but cannot output a correct signal due to some circumstances. As an example of the latter, the GNSS receiver 24 may be unable to receive navigation signals from the required number of navigation satellites due to the peripheral environment.

The information generation unit 61 generates the matching information so as to include a generation time point when the matching information is generated and the position information indicating a position of the vehicle 200 when the matching information is generated. The position information is information for specifying the position of the vehicle 200 when the matching information is generated. An example of the position information included in the matching information is coordinates. Another example of the position information included in the matching information is a road link or a lane link on which the vehicle 200 is traveling when the matching information is generated. If the vehicle 200 is located at an intersection when the matching information is generated, the position information may be a name of the intersection.

The matching information may include at least one of information indicating a condition under which a match is determined, weather, and version information of the map DB. The matching information further includes operation information indicating an execution status of the vehicle control of the vehicle controller 50 that controls the behavior of the vehicle. The operation information is information indicating whether the vehicle control is appropriately executed or cannot be executed. For example, in a case where the matching information is generated at a certain point but the traffic light stop control cannot be executed at a point, information indicating that the traffic light stop control cannot be executed is included in the operation information. The operation information may be information indicating an appropriate execution degree of the automated driving control.

The information compression unit 62 acquires pieces of matching information generated by the information generation unit 61, and combines the pieces of matching information into one piece of matching information having a small information amount in a continuation section in which the pieces of matching information continue. The information generation unit 61 generates the matching information periodically, for example, every several seconds, but the matching information may be continuous. In this case, the pieces of matching information are collected into one piece to reduce the amount of information. For example, the matching information is generated in association with these sections when the matching information is continuously generated from a first point to a second point while the vehicle 200 is traveling. As a result, for example, ten pieces of matching information can be collected into one piece of matching information, and the amount of information can be reduced as compared to before the collection. The information compression unit 62 stores the compressed matching information in the vehicle storage unit 30.

The information compression unit 62 controls the vehicle communication unit 40 to transmit the compressed matching information to the management server 80 at an arbitrarily set upload timing. The upload timing is, for example, every time vehicle control ends. Further, the upload timing may be when the vehicle 200 starts, that is, when the ignition switch is turned on. The upload timing may be periodic. After uploading the stored matching information from the vehicle communication unit 40 to the management server 80, the information compression unit 62 may delete the uploaded matching information from the vehicle storage unit 30.

The map update unit 63 updates the map information in the map DB when new map information is provided. The map update unit 63 updates the map information in the map DB when the vehicle communication unit 40 receives new map information from the management server 80.

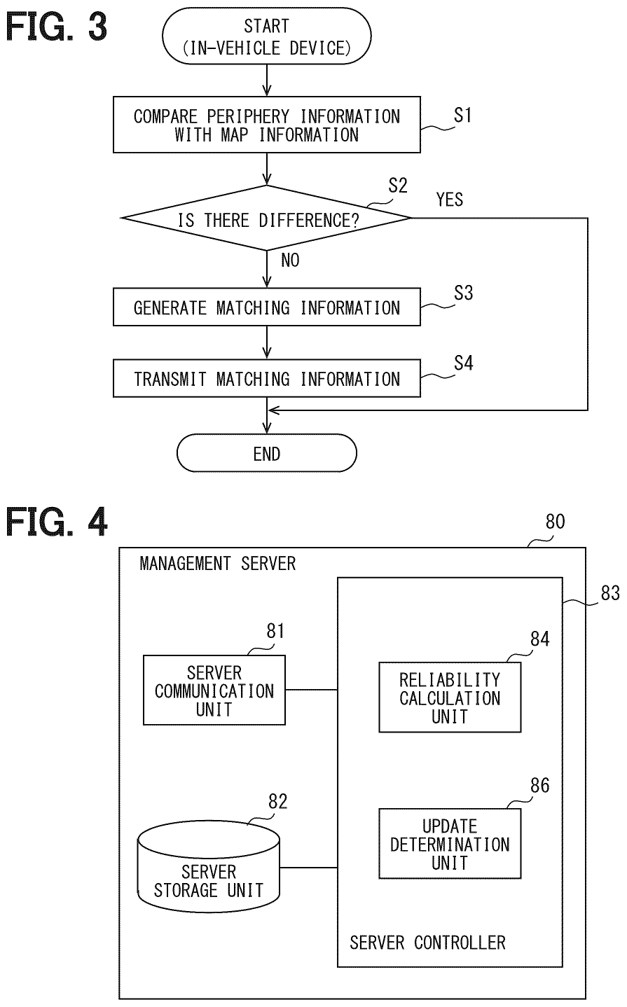

Next, control of the information generation unit 61 and the information compression unit 62 will be described with reference to a flowchart of FIG. 3. The flowchart shown in FIG. 3 is repeatedly executed by the in-vehicle device 60 in a short period of time.

In step S1, the periphery information is compared with the map information, and the process proceeds to step S2. In step S2, it is determined whether there is a difference between the periphery information and the map information. When there is no difference, the process proceeds to step S3, and when there is a difference, the process terminates.

In step S3, since there is no difference, the matching information is generated, and the process proceeds to step S4. In step S4, control is performed such that the matching information compressed by the information compression unit 62 is transmitted from the vehicle communication unit 40 to the management server 80, and the process terminates.

As a result, the matching information is transmitted to the management server 80 when there is no difference between the periphery information and the map information.

Next, a configuration of the management server 80 will be described with reference to FIG. 4. The management server 80 communicates with in-vehicle devices 60 mounted on vehicles 200 and manages the map information stored in vehicle storage units 30 of the in-vehicle devices 60. As shown in FIG. 4, the management server 80 includes a server communication unit 81, a server storage unit 82, and a server controller 83. The server communication unit 81 is a communication unit that communicates with the vehicle communication unit 40 via the communication network 300. The server communication unit 81 may be connected to the communication network 300 via a wired connection or wireless connection.

The server storage unit 82 stores a distribution map DB. The distribution map DB is a database that stores the map information to be distributed to the vehicle 200 in order to update part or all of the map DB stored in the vehicle storage unit 30. Therefore, the distribution map DB stores the latest map information.

The server controller 83 can be implemented by a configuration including at least one processor. For example, the server controller 83 can be implemented by a computer including a processor, a non-volatile memory, RAM, I/O, and a bus line connecting these configurations. The non-volatile memory stores a program for operating a general-purpose computer as the server controller 83. The processor executes the program stored in the non-volatile memory and uses a temporary storage function of the RAM.

When the server communication unit 81 receives the matching information, the server controller 83 performs control to store the received information in the server storage unit 82 together with a reception time point. The server controller 83 controls the server communication unit 81 to transmit the updated map information to the vehicle 200 when the map information in the distribution map DB is updated.

The server controller 83 grasps a change in the matching information in time series by accumulating the matching information. For example, when the matching information is periodically received from a certain point, but the matching information is not received from a certain point, it can be estimated that there is a factor for which the matching information cannot be generated at the point. Thus, the server controller 83 causes, for example, another device, for example, another inspection vehicle, to inspect the point. Therefore, a cause for which the matching information is not generated can be grasped at an earlier stage.

As shown in FIG. 4, the server controller 83 includes a reliability calculation unit 84 and an update determination unit 86 as functional blocks. Execution of the functional blocks correspond to an execution of a method implemented by execution of the program.

The reliability calculation unit 84 calculates reliability indicating certainty of the map information using the matching information. In addition, the reliability calculation unit 84 statistically processes the pieces of matching information to calculate the reliability when the matching information is acquired from the vehicles 200. The reliability calculation unit 84 acquires a traffic volume or an average traffic volume via the server communication unit 81. The reliability calculation unit 84 compares a number of received pieces of matching information with the traffic volume or the average traffic volume of the same road in the same time zone, and calculates the reliability of the matching information when the pieces of matching information are received in a certain time period. The reliability calculation unit 84 calculates, for example, a ratio obtained by dividing the number of received pieces of matching information by the traffic volume.

As an example, the reliability calculation unit 84 determines that the map information corresponding to the matching information in the map DB is correct and calculates the reliability to be high when the matching information is acquired at a certain ratio or more. The reliability is evaluated in levels, for example, five levels, and when the reliability is 5, the reliability is the highest. As described above, the reliability is calculated as 5 when the matching information is acquired at a certain ratio or more. On the other hand, a road, a point, and the like for which no matching information is received although there is a certain number of traffic volumes are calculated as reliability 1.

The reliability calculation unit 84 may calculate the reliability for each vehicle type, each time, and each information type when obtaining the reliability by statistical processing. For example, since detection accuracy of the periphery information may be different when the vehicle type is different, the reliability can be calculated more accurately by obtaining the reliability for each vehicle type. Further, since the reliability may be different depending on the time period, for example, when the reliability is different between daytime and nighttime, there is a high possibility that a different factor is brightness of the surroundings. Therefore, a cause of the difference in reliability can be pursued. Further, the reliability may be calculated for each information type, for example, the reliability of the matching information of the lane marking, the reliability of the matching information of the traffic light information, and the reliability of the position information of the position of the feature. Since the periphery information to be compared is different for each reliability, the detection accuracy may be different. Therefore, the reliability can be calculated more accurately by obtaining the reliability for each type.

The reliability calculation unit 84 may calculate the reliability by also using the operation information included in the matching information. Since the operation information is included in the matching information, it can be seen that the automated driving cannot be appropriately executed despite a presence of the matching information. For example, there may be another factor for instability of the lane keeping control that is not known only from the matching information when information of the lane is consistent but the lane keeping control is unstable at the time of turning at a curve. In this case, the reliability may be set low and the point of the curve may be inspected.

The update determination unit 86 uses the reliability to determine whether to update the map information. The update determination unit 86 determines that it is necessary to update the map DB when the reliability indicating that the map DB is correct is smaller than a threshold. In this case, another inspection device, for example, an inspection vehicle, investigates the point with low reliability and generates correct map information. Then, the server controller 83 creates update map data from the generated correct map information.

In addition, there may be a case where the map DB does not need to be updated as a result of investigating the point with low reliability by another inspection device. For example, when the lane marking is difficult to see due to aged deterioration, there is a difference between the lane marking of the map information and the lane marking of the periphery information, and thus the matching information is not generated. By performing image analysis or the like, the inspection device is capable of determining that a lane marking at the point of low reliability is a lane marking that has deteriorated over time and is not different from the lane marking in the map information, that is, matches the lane marking in the map information. In this case, it is not necessary to update the map information. Therefore, the reliability calculation unit 84 sets the reliability of the lane marking at this detection point such that updating is not necessary or the reliability is increased.

Similarly, for example, when a sign is difficult to see due to a shadow of a street tree, there is a difference between the sign of the map information and the sign of the periphery information, and thus the matching information is not generated. By performing image analysis or the like, the inspection device is capable of determining that a sign at the point with low reliability is a sign covered with another object and is not different from, that is, matches the sign in the map information. In this case, it is not necessary to update the map information. Therefore, the reliability calculation unit 84 sets the reliability of the sign at this detection point such that updating is not necessary or the reliability is increased.

The update determination unit 86 controls the server communication unit 81 to transmit the updated map information to the in-vehicle device 60 when updating the map information. The update determination unit 86 creates update map data when the update determination unit 86 determines that the map information needs to be updated. Then, the generated update map data is transmitted to the in-vehicle system 10. The map update unit 63 updates the map DB when the vehicle communication unit 40 receives this update map data. Note that the update map data may be transmitted by specifying a receiving party, or may be transmitted in a broadcast manner without specifying the receiving party. The receiver determines whether to update the update map data based on a version or the like of the update map data when transmitting update map data in a broadcast manner.

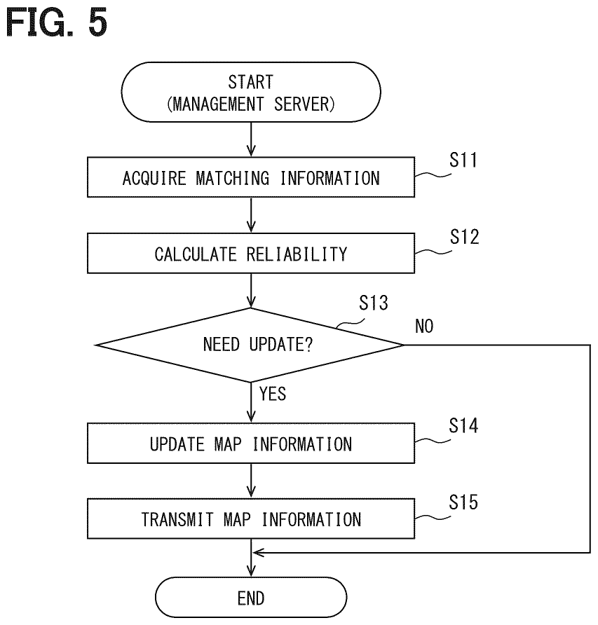

Next, control of the server controller 83 will be described with reference to the flowchart of FIG. 5. The flowchart shown in FIG. 5 is repeatedly executed by the management server 80 in a short period of time.

In step S11, the matching information is acquired via the server communication unit 81, and the process proceeds to step S12. In step S12, the reliability calculation unit 84 calculates the reliability using the matching information, and the process proceeds to step S13.

In step S13, the update determination unit 86 determines whether the map information needs to be updated. When the update is necessary, the process proceeds to step S14, and when the update is not necessary, the process terminates. In step S13, the update determination unit 86 determines necessity of the update using a threshold and the reliability. For example, when the reliability is equal to or less than 2, it is determined that the update is necessary.

In step S14, since the update is necessary, the map information in the distribution map DB is updated, and the process proceeds to step S15. In step S15, the server communication unit 81 is controlled to transmit the updated map information to the in-vehicle device 60, and the process terminates.

As described above, in the map information system 100 of the present embodiment, the information generation unit 61 generates the matching information indicating that the periphery information matches the map information when a difference between the periphery information detected by the periphery detection sensor 21 mounted on the vehicle 200 and the map information is within the allowable range. The matching information is information indicating that the map information is correct. The reliability calculation unit 84 calculates reliability indicating certainty of the map information using the matching information. Therefore, since the reliability of the map information can be known by generating the matching information, other vehicles 200 are capable of using the map information having high reliability.

In addition, the information generation unit 61 does not generate difference information indicating a mismatch. As a result, a processing load caused by generating the difference information and transmitting the difference information can be reduced.

Further, by calculating the reliability, a point, a road, a region, or the like having low reliability in the map information can identified. As a result, a cause of the low reliability can be investigated, the map information can be improved, or a cause that the map information is correct but the matching information is not generated can be clarified, and used for the vehicle control.

Further, the reliability calculation unit 84 may control the server communication unit 81 to transmit reliability information indicating that the reliability is high to each in-vehicle device 60 when the reliability is high, for example, when the reliability is 3 or more. The in-vehicle device 60 is capable of recognizing the reliability of the map information by receiving the reliability information. Thus, the in-vehicle device 60 is capable of executing the vehicle control using the map information in which the reliability is ensured.

In the present embodiment, when a difference between the periphery information and the map information is a difference in a position of a target feature, the information generation unit 61 generates the matching information when a change amount in the position of the feature is equal to or less than an allowable amount. As a result, when the position of the feature has a difference of a degree caused by an error or detection accuracy, the matching information is generated, so that correctness of the position of the feature in the map information can be grasped.

Furthermore, in the present embodiment, the information generation unit 61 generates the matching information when a type specified based on the sign information of the periphery information and the sign information of the map information match. Thus, the correctness of the type such as a sign of the map information can be grasped.

In the present embodiment, the information generation unit 61 specifies one traffic light by using a position of a traffic light with respect to the vehicle 200 and an orientation of the vehicle 200 when the periphery information includes information indicating detection of a plurality of traffic lights. The information generation unit 61 determines that the specified traffic light is within the allowable range and generates the matching information when the specified traffic lights matches the traffic light included in the traffic light information. Thus, even when traffic signals are detected, the correctness of the traffic light information in the map information can be grasped.

Further, in the present embodiment, the information generation unit 61 stops generating the matching information when the in-vehicle system 10 outputs abnormality information indicating an abnormality. In a case where the abnormality information is output, there is a possibility that the accuracy of the periphery information is lowered, and thus there is a possibility that it is not possible to appropriately determine whether the matching information is generated. As a result, possibility that low-accuracy matching information is generated can be reduced.

In the present embodiment, the information compression unit 62 acquires pieces of matching information generated by the information generation unit 61, and combines the pieces of matching information into one piece of matching information having a small information amount in a section in which the pieces of matching information continue. As a result, the amount of matching information can be reduced, a communication load can be reduced, and a required storage capacity can be reduced.

Further, in the present embodiment, the reliability calculation unit 84 statistically processes the pieces of matching information to calculate the reliability when the matching information is acquired from the vehicles 200. Since the matching information includes the generation time point and the position information, the reliability can be calculated more accurately by statistically processing pieces of matching information.

### Other Embodiments

The present disclosure is not limited to the preferred embodiments of the present disclosure described above. Various modifications may be made without departing from the subject matters of the present disclosure.

It should be understood that the configurations described in the above-described embodiments are example configurations, and the present disclosure is not limited to the foregoing descriptions. The scope of the present disclosure encompasses claims and various modifications of claims within equivalents thereof.

In the first embodiment described above, the management server 80 is configured to be outside the vehicle 200, but the configuration is not limited thereto. The management server 80 may be mounted on the vehicle 200. Therefore, the in-vehicle device 60 may include the function of the server controller 83 such as the update determination unit 86. The sign information may be information for specifying a type of at least one of a road sign, a road surface marking, and a lane marking.

In the first embodiment described above, the map update unit 63 of the in-vehicle device 60 updates the map DB online based on the update map data distributed from the management server 80, but the configuration is not limited thereto. The map DB may be updated offline.

In the first embodiment described above, the in-vehicle device 60 includes the information compression unit 62. However, the in-vehicle device 60 may not include the information compression unit 62. In this case, since the matching information is not compressed by the information compression unit 62, the matching information generated by the information generation unit 61 is accumulated and transmitted to the management server 80.

In the first embodiment described above, the information generation unit 61 does not generate the matching information when the abnormality information is output, but the configuration is not limited thereto. The information generation unit 61 may generate the matching information even when the abnormality information is output. In this case, it is preferable that the matching information includes warning information indicating that the abnormality information has been output.

In the above-described first embodiment, the functions realized by the in-vehicle device 60 and the server controller 83 may be realized by hardware and software different from those described above or by a combination of the hardware and the software. The in-vehicle device 60 and the server controller 83 may communicate with, for example, another control device, and the other control device may execute a part or all of the process. When the in-vehicle device 60 and the server controller 83 is realized by an electronic circuit, the in-vehicle device 60 and the server controller 83 may be realized by a digital circuit or an analog circuit, including a large number of logic circuits.

Whereas the in-vehicle device 60 is used in the vehicle 200 in the first embodiment mentioned before, the in-vehicle device 60 may be used not only in a state that it is mounted on a vehicle, but also in a state that the in-vehicle device 60 is not mounted on a vehicle at least partially.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A map information system configured to manage map information stored in a storage unit in a vehicle, comprising
an information generation unit configured:
to generate matching information indicating that periphery information, which is detected by a periphery detection sensor mounted on the vehicle, and the map information match each other when a difference between the periphery information and the map information is within an allowable range; and
not to generate difference information indicating that the periphery information and the map information do not match when the difference is out of the allowable range.

2. The map information system according to claim 1, wherein
the difference between the periphery information and the map information is a difference in a position of a target feature in the periphery information and the position of the target feature in the map information, and
the information generation unit is configured to determine that the difference between the periphery information and the map information is within the allowable range when an amount of the difference between the positions of the target feature is less than an allowable amount, and to generate the matching information.

3. The map information system according to claim 1, wherein
the map information includes sign information for specifying a type of at least one of a road sign, a road surface marking, and a lane marking,
the periphery information includes the sign information, and
the information generation unit is configured to determine that the difference between the periphery information and the map information is within the allowable range when a type specified by the sign information of the periphery information and a type specified by the sign information of the map information match each other, and to generate the matching information.

4. The map information system according to claim 1, wherein
the map information includes traffic light information for specifying a traffic light, and
the information generation unit is configured to:
specify one traffic light closest in a traveling direction of the vehicle among traffic lights by using positions of the traffic lights with respect to the vehicle and an orientation of the vehicle; and
determine that the difference between the periphery information and the map information is within the allowable range when the specified traffic light matches a traffic light included in the traffic light information, and to generate the matching information.

5. The map information system according to claim 1, wherein
the information generation unit is configured to stop generation of the matching information when an in-vehicle system mounted on the vehicle outputs abnormality information indicating an abnormality.

6. The map information system according to claim 1, further comprising,
an information compression unit configured to:
acquire pieces of the matching information generated by the information generation unit; and
combine the pieces of the matching information into one piece of the matching information having a small information amount for a section in which the pieces of the matching information continue.

7. The map information system according to claim 1, further comprising
a reliability calculation unit configured to calculate reliability indicating certainty of the map information by using the matching information, wherein
the matching information includes a generation time point when the matching information is generated and position information indicating a position of the vehicle when the matching information is generated, and
the reliability calculation unit is configured to calculate the reliability by statistically processing pieces of the matching information when the matching information is acquired from vehicles.

8. The map information system according to claim 1, wherein
the matching information includes operation information indicating an execution status of vehicle control of a vehicle controller configured to control behavior of the vehicle.

9. An in-vehicle device mounted on a vehicle comprising:
a storage unit configured to store map information;
an information generation unit configured:
to generate matching information indicating that periphery information, which is detected by a periphery detection sensor mounted on the vehicle, and the map information match each other when a difference between the periphery information and the map information is within an allowable range; and
not to generate difference information indicating that the periphery information and the map information do not match when the difference is out of the allowable range;
a vehicle communication unit configured to communicate with a management server, to transmit the matching information to the management server, and to receive new map information from the management server; and
a map update unit configured to update the map information in the storage unit when the new map information is received from the management server.

10. A management server configured to communicate with an in-vehicle device mounted on vehicles and to manage map information stored in a storage unit of the in-vehicle device, comprising:
a server communication unit configured to communicate with in-vehicle devices;
a reliability calculation unit configured to statistically process pieces of matching information, and to calculate reliability indicating certainty of the map information when the matching information is received from the in-vehicle devices;
an update determination unit configured to determine whether to update the map information using the reliability; and
a control unit configured to control the server communication unit to transmit updated map information to the in-vehicle device when the map information is updated, wherein
the matching information includes:
information generated when a difference between periphery information, which is detected by a periphery detection sensor mounted on the vehicle and the map information, and the map information is within an allowable range and indicating that the periphery information matches the map information;
a generation time point when the matching information is generated; and
position information indicating a position of the vehicle when the matching information is generated.
